(19) United States
(12) Patent Application Publication
(10) Pub. No.: US 2018/0311823 A1
(43) Pub. Date: Nov. 1, 2018

(54) Method for orienting an effector carrying an assembly tool relative to a surface

(71) Applicant: Airbus SAS, Blagnac (FR)

(72) Inventors: Marc DOUILLY, Albert (FR); Guillaume EVEN, Meaulte (FR)

(21) Appl. No.: 15/769,663

(22) PCT Filed: Oct. 28, 2016
(86) PCT No.: PCT/FR2016/052815

§ 371 Date: Apr. 19, 2018

(30) Foreign Application Priority Data
Oct. 29, 2015 (FR) 1560363

(51) Int. Cl. B25J 9/16

(52) U.S. Cl. CPC B25J 9/1684; G05B 2219/37008; G05B 2219/37404

(57) ABSTRACT

A method and a device for orienting an effector relative to a surface by means of a device comprising an articulated arm, at least one tool which is designed to carry out an assembly step, at least three sensors and a controller. The method comprises the steps of determining by the controller the position of the sensors on the effector and rotating the articulated arm according to at least one dimension, so as to orient the tool carried by the effector according to an angle which is predetermined relative to the normal to the surface.

### CROSS-REFERENCES TO RELATED APPLICATIONS

This application claims the benefit of the French patent application No. 1560363 filed on Oct. 29, 2015, the entire disclosures of which are incorporated herein by way of reference.

### TECHNICAL FIELD OF THE INVENTION

The present invention relates to a device and a method for measurement and correction of the orientation of an effector which is designed to orient the effector according to an angle which is predetermined relative to the work surface.

The present invention has a particularly advantageous application in guiding of robotized assembly operations, such as drilling, riveting or welding.

### BACKGROUND OF THE INVENTION

It is known in the prior art, during operations of assembly of aeronautical elements, and more particularly during drilling, to use robotized systems comprising a tool added on to the end of an articulated arm.

In order to guarantee the quality of the operation, the orientation of the tool must be ensured relative to the machined part with great precision of approximately a few tenths of a degree.

It is known in the prior art to use sensors to determine the position of the effector which carries the assembly tool relative to the machined part, then to displace the assembly tool, by means of a movement of the articulated arm, towards the area of the machined part where an assembly operation is necessary. Once the tool has been put into position, the orientation is corrected. Mostly, the assembly method makes it necessary to orient the assembly tool according to the normal relative to the plane defined by the surface to be worked on the machined part.

In the present solutions, the orientation is corrected once the effector is in position brought alongside the panel. This involves sequential operation, i.e., bringing alongside, normality, then action of the effector. In other words, in the existing solutions, the effector comes into contact with the surface, measures angular offsetting between the real position of the effector and the required position, then sends a command to the robot to carry out a movement of correction of the orientation of the position of the effector.

Solutions of this type with laser sensors developed by the companies Brötje (registered trademark) and Alema (registered trademark) are available, in particular.

A solution is also disclosed in French patent no. FR 2 897 009 B1, which describes a method for positioning, relative to a surface, an effector comprising at least one tool which is designed to carry out a step of assembly, with the effector being added on to the end of an articulated arm which, by means of the effector, can apply a force against the surface, with the effector comprising a frontal wall opposite the surface.

The effector which is described in French patent no. FR 2 897 009 B1 can measure a relative movement between the frontal wall and a support plate comprising at least one part which can be supported directly or indirectly against the surface, and can be immobile relative to the surface, and connected to the frontal plate.

Thus, the effector can be displaced in at least one direction, and can command the articulated arm so that it carries out a movement designed to compensate for the relative movement measured.

The solutions known in the prior art are rigid, in other words they are of the type in which the sensors, their positions and their numbers are fixed, and any modification of one of these parameters is impossible without rethinking the entire system.

The number of sensors is, in principle, established as three or four, which is the minimum number necessary in order to calculate the orientation of one plane relative to another. Their positions are previously defined in a favorable location, and where the calculations are simple, for example with offsetting of 120° between two successive sensors.

However, none of the present systems makes it possible to comply simultaneously with all the requirements, i.e., of permitting the orientation according to a predetermined angle of an effector relative to any surface, or the number of sensors used, or their positioning.

In addition, the present systems do not permit correction of orientation simultaneously with a movement of the robot.

### SUMMARY OF THE INVENTION

An objective of the present invention is to eliminate some or all of these disadvantages.

For this purpose, according to a first aspect, the invention concerns a method for orienting an effector relative to a surface by means of a device comprising an articulated arm, at least one tool which is designed to carry out an assembly step, at least three sensors and a controller, which method comprises the following steps:
determination, by the controller, of the position and the orientation of the sensors on the effector;
rotation of the articulated arm according to at least one dimension, so as to orient the tool carried by the effector according to an angle which is predetermined relative to the normal to the surface.

Due to these arrangements, the method which is the subject of the invention makes it possible to ensure the orientation of a tool during assembly operations, such as drilling or riveting. The method which is the subject of the invention makes it possible to dispense with the constraints relating to the number of sensors used, and to their positioning. Thus, the invention makes it possible to facilitate the integration of the sensors by dispensing with the steps before assembly and of adjustment on an effector, and thus to save cycle time.

In some embodiments, the sensors also measure the distance between the surface and the effector.

Due to these arrangements, the distance between each sensor and the surface to be worked is known at all times. These arrangements facilitate, in particular, the correction of the orientation of the effector in movement between two successive assembly operations.

In some embodiments, the step of rotation is carried out simultaneously with a displacement of the effector relative to the surface.

Due to these arrangements, the orientation of the tool can be adjusted during the time taken by the robot to travel between two discrete assembly operations, such as riveting or drilling operations. The tool already comes into position on the surface where an assembly operation is necessary, which makes it possible to reduce the time of the operation. In addition, these arrangements make it possible to carry out continuously assembly operations, such as welding by friction for example. In this case, the assembly tool is rotated during the movement of the tool.

These arrangements make it possible to reduce the cycle time of a drilling or riveting operation, for example, and thus to reduce its costs.

In some embodiments, the step of determination of the position of the sensors on the effector comprises the following steps:
acquisition of a first set of measurements carried out by each of the sensors on two predetermined distinct positions of the effector, with the effector being positioned by an operator relative to the normal to the surface;
calculation of the position and the orientation of the sensors from the first set of measurements.

Due to these arrangements, the method, which is the subject of the invention, permits measurement of the position and the orientation of the sensors to within a degree.

In some embodiments, the step of determination of the position of the sensors on the effector comprises the following steps:
acquisition of a second set of measurements carried out by each of the sensors on at least two distinct positions of the effector, with the effector carrying out at least one movement of rotation and a plurality of measurements being taken during the rotation of the effector;
determination by the controller of the position and the orientation of the sensors on the effector from the second set of measurements.

Due to these arrangements, the method which is the subject of the invention permits measurement of the position and the orientation of the sensors to within a 10th of a degree.

In some embodiments, the step of acquisition of a first set of measurements comprises the following steps:
positioning of the effector on a first predetermined plane, which is perpendicular to the normal relative to the surface;
measurement for each of the sensors of a predetermined physical item of data;
positioning of the effector on a second predetermined plane, which is perpendicular to the normal relative to the surface;
measurement for each of the sensors of a predetermined physical item of data.

In some embodiments, the determination of the position of the sensors on the effector in the step is carried out by application of a non-linear optimization algorithm from the first and second sets of measurements.

In some embodiments, the first plane is flush with the wall of the surface.

In some embodiments, the distance between the effector and the second plane is greater than the distance between the effector and the first plane.

In some embodiments, at least one sensor is a laser sensor.

Due to these arrangements, the measurements which are carried out by the sensor can be carried out remotely. These arrangements make it possible to correct the position of the effector without contact with the work surface.

In some embodiments, at least one sensor is an inductive sensor.

Due to these arrangements, the measurements which are carried out by the sensor can be carried out remotely. These arrangements make it possible to correct the position of the effector without contact with the work surface.

In some embodiments, at least one sensor is a force sensor.

According to a second aspect, the invention concerns a device for implementation of the above-described method, which device comprises an effector comprising at least one tool which is designed to carry out an assembly step, an articulated arm, a plurality of sensors, and a controller comprising input modules and output modules, the effector being added on to the end of the articulated arm.

Since the particular objectives, advantages and characteristics of this system are similar to those of the method which is the subject of the present invention, they are not described again here.

### BRIEF DESCRIPTION OF THE DRAWINGS

Other particular advantages, objectives and characteristics of the invention will become apparent from the following non-limiting description of at least one particular embodiment of the method and device which are the subject of the present invention, with reference to the appended drawings in which:

FIG. 1 represents, in the form of a logic diagram, a particular embodiment of the method which is the subject of the invention, for orientation of an effector relative to a surface;

FIG. 2 represents, in the form of a diagram in cross-section, a particular embodiment of the device for implementation of the method which is the subject of the invention.

### DETAILED DESCRIPTION OF THE PREFERRED EMBODIMENTS

The present description is provided on a non-limiting basis, each characteristic of an embodiment advantageously being able to be combined with any other characteristic of any other embodiment.

It should hereby be noted that the figures are not to scale.

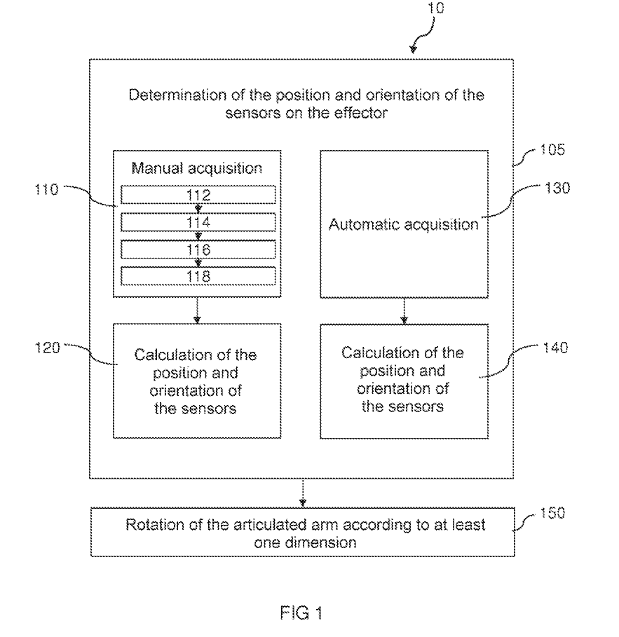

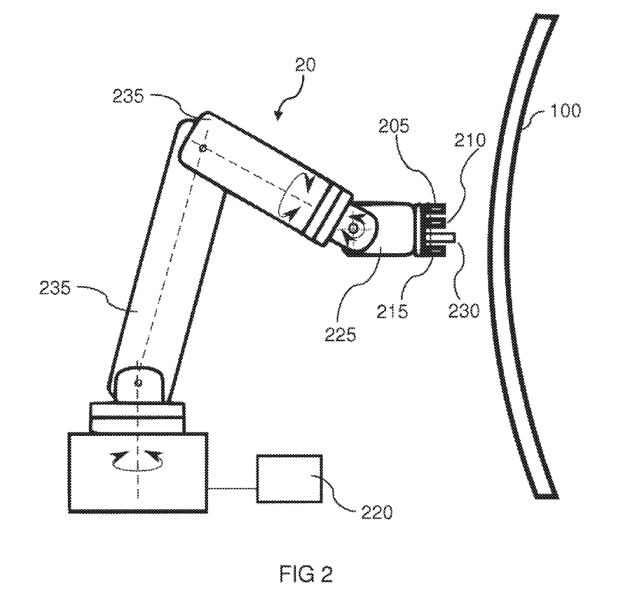

FIG. 1 shows a method 10 for orientation of an effector 225 relative to a surface 100, by means of a device 20, illustrated in FIG. 2, comprising an articulated arm, at least one tool which is designed to carry out a step of assembly, at least three sensors 205, 210, 215 and a controller 220, which method comprises the following steps:
determination 105, by the controller, of the position and the orientation of the sensors 205, 210, 215 on the effector 225;
rotation 150 of the articulated arm according to at least one dimension, so as to orient the tool carried by the effector 225 according to an angle which is predetermined relative to the normal to the surface 100.

During the step 105, the position and the relative orientation of the sensors 205, 210, 215 present on the effector 225 relative to the surface 100 are determined. The step 105 makes it possible to position the effector 225, and thus the tool carried by the effector 225, according to an angle predetermined in the step 150, irrespective of the position of the sensors on the effector 225.

The step 105 comprises at least one measurement by each of the sensors 205, 210, 215 of at least one item of data representative of a physical value and a calculation, from the set of measurements acquired, of the position and the orientation of the sensors 205, 210, 215 on the effector 225.

In some embodiments, the step 105 comprises a so-called manual step 110 of acquisition of a first set of measurements. In some embodiments, the step 105 comprises a so-called automatic step 130 of acquisition of a second set of measurements. In some preferred embodiments, the step 105 comprises a so-called manual acquisition 110 and a so-called automatic acquisition 130.

The values measured can, for example, be the distance between the sensor and the surface 100, or a force applied by the surface 100 on the sensor. The value measured by the sensor is sent to the controller, which processes the information and carries out the calculation steps. In some embodiments, the connection between the sensors and the controller is sent in the form of an analog signal. In other embodiments, the signal sent by the sensors to the controller is a digital signal.

On the basis of the measurements acquired by the sensors, the controller determines the orientation of the assembly tool carried by the effector 225 relative to the surface 100. Then, the calculated orientation of the tool is compared by the controller with a predetermined target orientation necessary in order to carry out an assembly operation. The controller issues a command to the articulated arm, so that the articulated arm carries out a movement in order to orient the assembly tool according to an angle which is predetermined relative to the surface 100.

In some embodiments, which, in particular, are designed for drilling operations, the tool is positioned normal to the surface 100 in the step 150 of rotation of the articulated arm.

In some embodiments, the method according to the invention carries out a series of assembly operations in succession on a single part. In this embodiment, the so-called manual acquisition step 110 can be carried out a single time for a plurality of assembly operations. In this embodiment, the so-called automatic acquisition step 130 can be carried out before each assembly operation.

In some embodiments, the sensors 205, 210, 215 also measure the distance between the surface 100 and the effector 225.

In some embodiments, the step 150 of rotation is carried out simultaneously with a displacement of the effector 225 relative to the surface 100. This embodiment is particularly suitable for carrying out a continuous assembly operation such as welding.

In some embodiments, the step 105 of determination of the position of the sensors on the effector 225 comprises the following steps:
acquisition 110 of a first set of measurements carried out by each of the sensors 205, 210, 215 on two predetermined distinct positions of the effector, with the effector being positioned by an operator normal relative to the surface 100;
calculation 120 of the position and the orientation of the sensors 205, 210, 215 from the first set of measurements.

In some embodiments, the step 105 of determination of the position of the sensors on the effector 225 comprises the following steps:
acquisition 130 of a second set of measurements carried out by each of the sensors 205, 210, 215 on at least two distinct positions of the effector 225, with the effector carrying out at least one movement of rotation, and a plurality of measurements being taken during the rotation of the effector;
determination 140 by the controller of the position and the orientation of the sensors on the effector from the second set of measurements.

This embodiment is complementary to the step 120 of calculation of the position and of the orientation of the sensors 205, 210, 215 from the first set of measurements. The results obtained in the step 120 can be used to initialize the parameters for the purpose of a non-linear optimization carried out in the step 140.

In some embodiments, the step 110 of acquisition of a first set of measurements comprises the following steps:
positioning 112 of the effector 225 on a first predetermined plane, perpendicular to the normal relative to the surface 100;
measurement 114 for each of the sensors of a predetermined physical item of data;
positioning 116 of the effector 225 on a second predetermined plane, perpendicular to the normal relative to the surface 100;
measurement 118 for each of the sensors of a predetermined physical item of data.

In some embodiments, the determination of the position of the sensors on the effector 225 in the step 140 is carried out by application of a non-linear optimization algorithm from the first and second sets of measurements.

In some embodiments, the step 140 of non-linear optimization comprises a calculation step using a Levenberg-Marquardt algorithm

In some embodiments, the first plane is flush with the wall of the surface 100.

In some embodiments, the distance between the effector 225 and the second plane is greater than the distance between the effector 225 and the first plane.

In some embodiments, at least one sensor is a laser sensor. In the embodiments which implement a laser sensor, the physical value measured is the distance. The sensor projects a ray onto the surface 100, which in turn returns the ray of light. The sensor acquires the ray of light reflected, then, the travel time measured, or phase difference, between the emission and the reception, makes it possible to calculate the distance.

In some embodiments, at least one sensor is an inductive sensor.

Inductive sensors form part of the category of proximity sensors which are characterized by the absence of a link between the sensor and the object. The detection is thus carried out by means of a field which can be electric, magnetic or electromagnetic.

Proximity sensors exist in two modes, i.e., analog or binary. In the case of the binary mode, the signal is either high or low according to the distance. The analog mode makes it possible to have a signal which is dependent on the distance separating the sensor from the surface 100.

In some embodiments, at least one sensor is an inductive sensor with variable reluctance. Inductive sensors with variable reluctance are sensors constituted by a permanent magnet placed inside a coil. When a metal object is placed in the vicinity of the sensor, the magnetic reluctance of the circuit (capacity of the circuit to oppose the input of a magnetic field) varies, and permits the creation of a current in the coil.

In some embodiments, at least one sensor is an inductive sensor with Foucault currents. Inductive sensors with Foucault currents are sensors which produce an oscillating magnetic field at their end. When a metal object passes into this magnetic field, the latter is either attenuated or disrupted, depending on the nature of the metal. The magnetic field created at the end of the sensor is obtained from a coil subjected to a sinusoidal voltage with a low frequency of approximately a few kilohertz.

In some embodiments, at least one sensor is an inductive sensor of any other type.

In some embodiments, at least one sensor is a force sensor. The force sensor measures a force applied to an object and converts it into an electric signal.

FIG. 2 shows a particular embodiment of the device 20 for implementation of the method which is the subject of the invention, comprising an effector 225 comprising at least one tool which is designed to carry out an assembly step, an articulated arm 235, a plurality of sensors 205, 210, 215, and a controller 220 comprising input modules and output modules, the effector being added on to the end of the articulated arm 235.

The device 20 comprises at least three sensors 205, 210, 215. In some embodiments, the device 20 comprises a number of sensors which is more than three.

In some embodiments, the controller 220 of the system is complemented by a second controller (not represented) specific to the robot which carries the articulated arm 235. In this embodiment, the controller 220 of the system carries out all of the calculation steps on the basis of the data gathered by the sensors, then issues commands which it transmits in analog or digital form to the controller of the robot, which then makes the articulated arm 235 execute the movement.

In some embodiments, the signal which is emitted by at least one sensor 205, 210, 215 to the controller 220 during the acquisition of measurements is an analog signal. In some embodiments, the signal which is emitted by the controller 220 to the articulated arm 235 to order a movement is an analog signal.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-13. (canceled)

14. A method for orienting an effector relative to a surface by means of a device comprising an articulated arm, at least one tool which is configured to carry out an assembly step, at least three sensors and a controller, wherein the method comprises the following steps:
determining, by the controller, a position and an orientation of the at least three sensors on the effector;
rotating the articulated arm according to at least one dimension, so as to orient the tool carried by the effector according to an angle which is predetermined relative to the normal to the surface.

15. The method as claimed in the claim 14, wherein the at least three sensors also measure a distance between the surface and the effector.

16. The method as claimed in claim 14, wherein the rotating step is carried out simultaneously with a displacement of the effector relative to the surface.

17. The method as claimed in claim 14, wherein the step of determining the position of the sensors on the effector comprises the following steps:
manually acquiring a first set of measurements carried out by each of the at least three sensors on two predetermined distinct positions of the effector, with the effector being positioned by an operator normal relative to the surface;
calculating the position and the orientation of the at least three sensors from the first set of measurements.

18. The method as claimed in claim 14, wherein the step of determining the position of the sensors on the effector comprises the following steps:
automatically acquiring a second set of measurements carried out by each of the at least three sensors on at least two distinct positions of the effector, with the effector carrying out at least one movement of rotation and a plurality of measurements being taken during the rotation of the effector;
determining, by the controller, of the position and the orientation of the at least three sensors on the effector from the second set of measurements.

19. The method as claimed in claim 17, wherein the step of manually acquiring a first set of measurements comprises:
positioning the effector on a first predetermined plane, which is perpendicular to the normal relative to the surface;
measuring, for each of the at least three sensors, a predetermined physical item of data;
positioning the effector on a second predetermined plane, which is perpendicular to the normal relative to the surface;
measuring, for each of the at least three sensors, a predetermined physical item of data.

20. The method as claimed in claim 17, wherein the step of determination of the position of the sensors on the effector comprises the following steps:
automatically acquiring a second set of measurements carried out by each of the at least three sensors on at least two distinct positions of the effector, with the effector carrying out at least one movement of rotation and a plurality of measurements being taken during the rotation of the effector;
determining, by the controller, the position and the orientation of the at least three sensors on the effector from the second set of measurements, and
wherein the determining the position of the at least three sensors on the effector in the step is carried out by application of a non-linear optimization algorithm from the first and second sets of measurements.

21. The method as claimed in claim 19, wherein the first predetermined plane is flush with the wall of the surface.

22. The method as claimed in claim 19, wherein a distance between the effector and the second predetermined plane is greater than a distance between the effector and the first predetermined plane.

23. The method as claimed in claim 14, wherein at least one of the at least three sensors is a laser sensor.

24. The method as claimed in claim 14, wherein at least one of the at least three sensors is an inductive sensor.

25. The method as claimed in claim 14, wherein at least one of the at least three sensors is a force sensor.

26. A device for implementation of the method as claimed in claim 14, comprising an effector comprising at least one tool which is configured to carry out an assembly step, an articulated arm, a plurality of sensors, and a controller comprising input modules and output modules, said effector being arranged on an end of the articulated arm.
